(19) United States
(12) Patent Application Publication
(10) Pub. No.: US 2011/0185038 A1
(43) Pub. Date: Jul. 28, 2011

(54) APPARATUS AND METHOD FOR PROVIDING A TERMINAL WEB SERVICE

(76) Inventors: Seok-Hyun Yoon, Seongnam-si (KR); Sung-Ho Ryu, Suwon-si (KR); Dong-Joon Hyun, Seoul (KR); Min-Hyok Bang, Seoul (KR); Dong-Hun Park, Suwon-si (KR); Hee-Seon Park, Seoul (KR)

(21) Appl. No.: 12/967,240

(22) Filed: Dec. 14, 2010

(30) Foreign Application Priority Data
Jan. 28, 2010 (KR) 10-2010-0008107

(51) Int. Cl. G06F 15/16

(52) U.S. Cl. 709/217

(57) ABSTRACT

An apparatus and method for providing a terminal web service capable of being associated with data and/or native operations of a terminal while using a rich internet application are provided. The terminal apparatus includes a web application providing unit and a terminal web service providing unit. The web application providing unit discovers a terminal web service control script, which performs control to achieve association with respect to a terminal web service provided by the terminal apparatus, by executing a client script received from an external web server and to generate a hypertext transport protocol (HTTP) request message for requesting the terminal web service by use of the terminal web service control script. The terminal web service providing unit is configured to, upon reception of the HTTP request message, provide the terminal web service by sending the web application providing unit a HTTP reply message for providing reply information by the terminal web service.

### CROSS-REFERENCE TO RELATED APPLICATION

This application claims the benefit under 35 U.S.C. §119(a) of Korean Patent Application No. 10-2010-0008107, filed on Jan. 28, 2010, in the Korean Intellectual Property Office, the entire disclosure of which is incorporated herein by reference for all purposes.

### BACKGROUND

1. Field

The following description relates to a web information providing technology that is based on a rich internet application.

2. Description of the Related Art

As the speed of mobile communication networks increase, the development of wireless internet, mobile technology, and mobile terminals has accelerated. In addition, with the increase of portable terminal apparatuses that may be used to access an internet service, such as a Portable Multimedia Player (PMP), a MP3 player, a GPS navigator, a portable game console, a personal digital assistant (PDA), an ultra mobile personal computer (UMPC), a smart phone, and the like, the desire for a method to effectively access a large amount of web information in a mobile environment has increased.

One example for accessing a large amount of web information is a rich internet application. A rich internet application allows a web application operating on a personal computer to be used on a mobile terminal in full browsing. Full browsing refers to browsing which provides support such that a web page, for example, a web page in hyper text markup language (HTML), that is in a language other than a wireless application protocol based web page written in wireless markup language (WML), may be accessed using a mobile terminal using an application such as INTERNET EXPLORER® or FIREFOX® located on a personal computer.

An advantage of using a rich internet application method is that a service provider does not need to develop and distribute an additional web service for a mobile terminal or install an additional program for a mobile terminal.

### SUMMARY

In one general aspect, there is provided a terminal apparatus comprising a web application providing unit configured to discover a terminal web service control script, which performs control to achieve association with respect to a terminal web service provided by the terminal apparatus, by executing the client script received from the external web server, and configured to generate a hypertext transport protocol (HTTP) request message for requesting the terminal web service by use of the terminal web service control script, and a terminal web service providing unit configured to, upon reception of the HTTP request message, provide the terminal web service by sending the web application providing unit a HTTP reply message for providing reply information of the terminal web service.

The client script may be received in a rich internet application that runs based on a full browser.

The web application providing unit may embed the terminal web service control script in the web application providing unit by use of the client script, and may communicate with the terminal web service providing unit by use of the terminal web service control script.

The web application providing unit may send information included in the HTTP reply message to the external web server and may send information received from the external web server to the terminal web service providing unit, by use of the client script.

The terminal web service control script may include at least one of a device and service description script that indicates terminal related information and terminal web service information provided by the terminal apparatus, a terminal web service associating script written to call the terminal web service, a cross domain script that enables HTTP communication with the terminal web service through a java script, and an event monitor script that detects an event that occurs in the terminal web service providing unit.

The terminal web service providing unit may provide a terminal data providing web service that forms data stored in the terminal apparatus into the HTTP reply message and may provide the HTTP reply message to the web application providing unit.

The terminal web service providing unit may provide a terminal application executing web service that executes an application executable in the terminal apparatus.

If the web application providing unit registers inquiry of at least one event occurring in the terminal apparatus by use of the client script, the terminal web service providing unit may provide a terminal event web service that enables the web application providing unit to inquire into state information of the event.

The terminal web service providing unit may further comprise a terminal event manager configured to manage an event occurring in the terminal apparatus and store state information of the event, and the web application providing unit may inquire into the stored state information of the event through the terminal event web service.

The event may include a hardware event occurring in hardware of the terminal apparatus and a software event corresponding to a predetermined operation of an application executed in the terminal apparatus.

The web application providing unit may determine if obtained state information of an event satisfies a preset requirement by use of the client script, and if satisfied, may run a preset handler.

In another aspect, there is provided a method of providing a terminal web service of a terminal apparatus, the method comprising at a web application providing unit, receiving a client script, which is configured to be associated with a terminal web service provided by a terminal web server, from an external web server connected through a network, at the web application providing unit, executing the client script received from the external web server to discover a terminal web service control script, which performs control to achieve association with respect to the terminal web service, by use of the client script, at the web application providing unit, generating an HTTP request message for requesting the terminal web service by use of the terminal web service control script, at the web application providing unit, sending the generated HTTP request message to a terminal web service providing unit, and at the terminal web service providing unit, sending the web application providing unit a HTTP reply message for providing the terminal web service, upon reception of the HTTP request message.

The method may further comprise, at the web application providing unit, embedding the terminal web service control script into the web application providing unit by use of the client script.

The sending of the HTTP reply message for providing the web service to the web application providing unit may comprise providing a terminal data providing web service that generates data stored in the terminal apparatus into the HTTP reply message and provides the HTTP reply message to the web application providing unit.

The sending of the HTTP reply message for providing the web service to the web application providing unit may comprise providing an execution result of a terminal application executing web service that executes an application executable in the terminal apparatus.

The sending of the HTTP reply message for providing the web service to the web application providing unit may comprise providing a terminal event web service that allows the web application providing unit to inquire into state information of an event.

The method may further comprise, at the terminal web service providing unit, managing an event occurring in the terminal apparatus and storing state information of the event, wherein the sending of the HTTP reply message for providing the web service to the web application providing unit may comprise inquiring into the stored state information of the event according to the execution of the terminal event web service and sending the web application providing unit obtained state information.

In another aspect, there is provided a terminal comprising a web application providing unit configured to receive data including a client script of a web application running on an external web server, from the external web server, configured to execute the client script to discover a terminal web service control script that corresponds to a terminal web service that enables a browsing service to be used with data and native operations of the terminal, and configured to transmit a request for the terminal web service, and a terminal web service providing unit configured to receive the terminal web service request and configured to provide the terminal web service and the data and native operations of the terminal based on the terminal web service control script.

The data and the native operations of the terminal provided to the web application providing unit may include at least one of short message services (SMS), multimedia messaging services (MMS), schedule information, location information, and playback history information.

The terminal web service may enable native programs of the terminal to be invoked by the web application running on the external web server, and the programs include at least one of a photo viewer program and an mp3 player installed in the terminal.

Other features and aspects may be apparent from the following description, the drawings, and the claims.

### BRIEF DESCRIPTION OF THE DRAWINGS

FIG. 1 is a diagram illustrating an example of a system architecture for providing a mobile mash up service.

FIGS. 2A and 2B are diagrams illustrating examples of a controller included in a terminal.

FIG. 3 is a diagram illustrating an example of a client script included in a web application.

FIG. 4 is a diagram illustrating an example of a terminal web service control script.

FIG. 5 is a diagram illustrating an example of a web service provided by a terminal.

FIG. 6 is a diagram illustrating an example of a terminal event manager provided by a terminal.

FIG. 7 is a flowchart illustrating an example of a method for providing a terminal web service.

FIG. 8 is a flowchart illustrating an example of an initial process for a terminal web service association.

FIG. 9 is a flowchart illustrating an example of a method for providing a terminal data providing web service.

FIG. 10 is a flowchart illustrating an example of a method for providing a terminal application executing web service.

FIG. 11 is a flowchart illustrating an example of a method for providing a terminal event web service.

Throughout the drawings and the description, unless otherwise described, the same drawing reference numerals should be understood to refer to the same elements, features, and structures. The relative size and depiction of these elements may be exaggerated for clarity, illustration, and convenience.

### DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

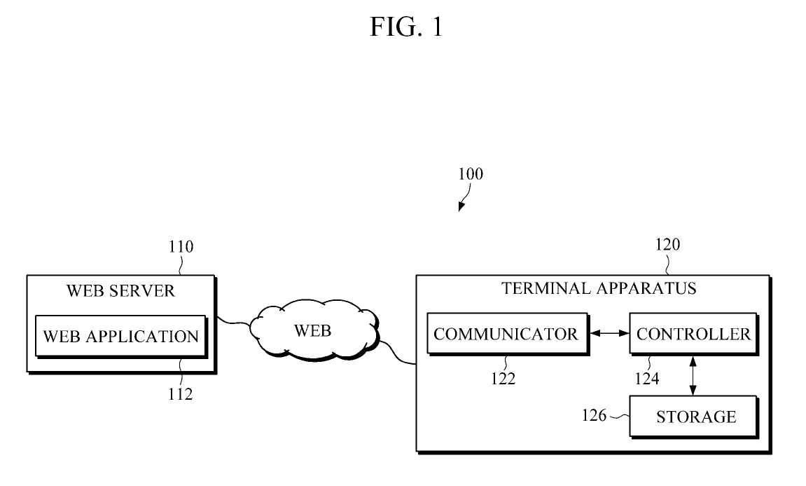

FIG. 1 illustrates an example of a system architecture for providing a mobile mash up service.

Referring to FIG. 1, system 100 for providing a mobile mash up service includes a web server 110 and a terminal apparatus 120.

The web server 110 runs a web application 112 for providing a web site. The web server 110 may provide a web application 112 that is developed based on a rich internet application (RIA) that allows a web application to be used by a mobile terminal.

For example, the terminal apparatus 120 may be a mobile terminal apparatus that provides a user the ability to browse on the internet. For example, the mobile terminal apparatus may be a PMP, a MP3 player, a navigator, a portable game console, a PDA, a UMPC, a smart phone, and the like. In this example, the terminal apparatus 120 includes a communicator 122, a controller 124, and a storage 126. The communicator 122 may communicate with the web server 110 through a network. The controller 124 controls the overall operations of the terminal apparatus 120. The controller 125 executes a web browser that may be executed by downloading the web application 112 and provides a terminal web service. The storage 126 stores various kinds of data such as device related information, one or more operating systems, applications, photos, moving pictures, audio files, documents, and the like, in the terminal apparatus 120. In various embodiments, the terminal apparatus 120 may further include an audio output apparatus, a display, and/or a user input device.

The terminal apparatus 120 may interact with the web server 110 and use various contents and web functions using the web applications 112 provided by the web server 110. In addition, the terminal apparatus 120 may use a full browsing service implementing documents and moving pictures as they are represented on an internet site through wireless internet.

A conventional rich internet application based web service is not associated with data or native operations of a terminal. However, the terminal apparatus 120 provides a terminal web service which allows a rich internet application based web application provided through a full browsing service to be used with data and/or native operations of a terminal, thereby implementing a mobile mash up service. For example, the terminal web service may interact with at least one of data stored in the terminal apparatus 120, an application executable in the terminal apparatus 120, various events occurring in the terminal apparatus 120, and the like.

As one example, the web server 110 may provide a sound source site through the web application 112 and the terminal apparatus 120 may store audio files and an audio file player. While a user is listening to music B sung by singer A through the audio file player, the user may visit a sound source site provided by the web server 110 to listen to other music sung by singer A by running a web browser. In this example, the terminal apparatus 120 may send the web server 110 information stored in the terminal apparatus 120 for logging in to the sound source site stored in the terminal apparatus 120 by use of the terminal web service. In addition, the terminal apparatus 120 may send playback information about music B sung by singer A. As a result, the web server 110 may recommend another music C that is sung by the singer A by checking the user of the terminal apparatus 120 and referring to the playback information, without the need for the user to log-in to the sound source site.

While a user is previewing a music C, for example, if the user shakes the terminal apparatus 120 in a left/right directions, an event corresponding to the shake may be transferred to the web server 110 using a terminal web service. In response, the web server 110 may change the music being previewed into a music D sung by the singer A. Subsequently, the web server 110 may transfer the preview music D changed from the music C to the terminal apparatus 120, and the terminal apparatus 120 may play the changed preview music D using the audio file player. As described above, by shaking the terminal apparatus 120, the user may change a preview of music.

As another example, the user may use a sound source recommendation service without having to send the web server 110 personal information, such as preference information of the user or playback details of sound sources. The user may visit a sound source site provided by the web server 110 by running a web browser on the terminal apparatus 120. The web application 112 may check if the terminal apparatus 120 has a music recommendation web service serving as the terminal web service, by use of terminal web service information provided by the terminal apparatus 120. For example, the web application 112 may download a music chart of the week provided by the sound source web site to the terminal apparatus 120 and may transfer the downloaded music chart to the music recommendation web service. In response, the music recommendation music web service may recommend music based on the preference of the user from among sound sources included in the downloaded music chart and may play the music through a music player that is loaded on the terminal apparatus 120.

As another example, the terminal apparatus 120 may upload data, such as photos and moving pictures, stored in the terminal apparatus 120 to the web server 110 through the web application 112 using the terminal web service without having to use an upload program designed for loading data to the web server 110.

The above-described examples are merely for purposes of example, and it should be appreciated that the mobile mash up service may be implemented in various forms.

Through such a mobile mash up service, a service provider may provide a user with a web application that is associated with native data and functions of the terminal without the need for a complicated distribution process. In addition, a manufacturer of the terminal apparatus may open native data or operations of the terminal, thereby activating an open market. By creating a more open market, data and function of the terminal increases the amount of web services which may be associated with and used by the terminal. By increasing the amount of the web applications that are compliant with the terminal, a manufacture may strive for a web service standardization of like products or similar products. In addition, a user of the terminal apparatus 120 may receive personalized service without having to send data of the terminal to a server, and thus, the privacy of the terminal is increased and unnecessary network traffic is reduced in the costly wireless internet network.

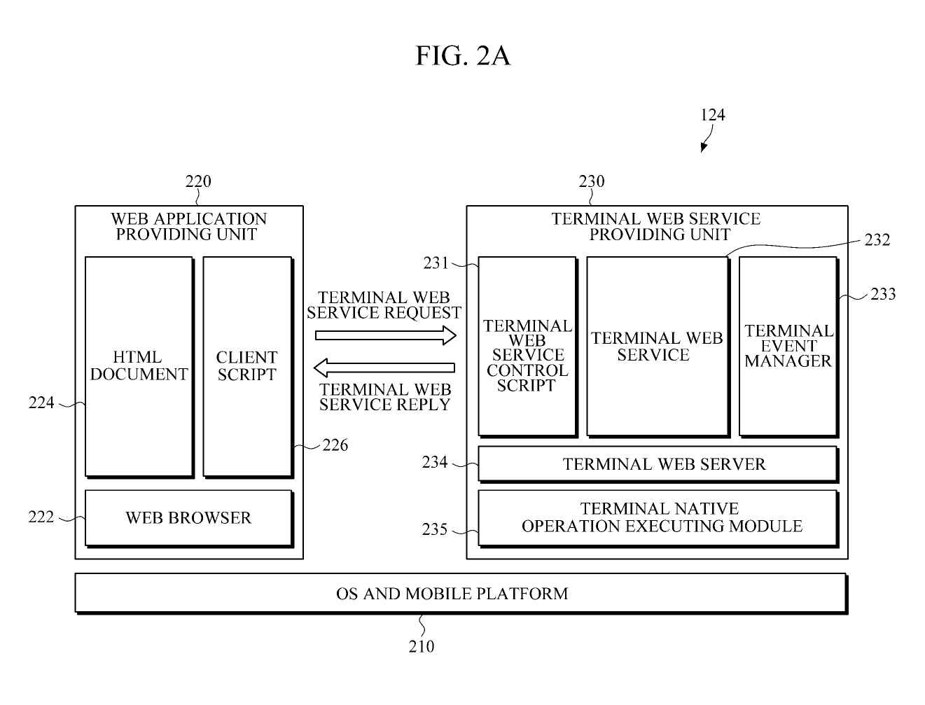

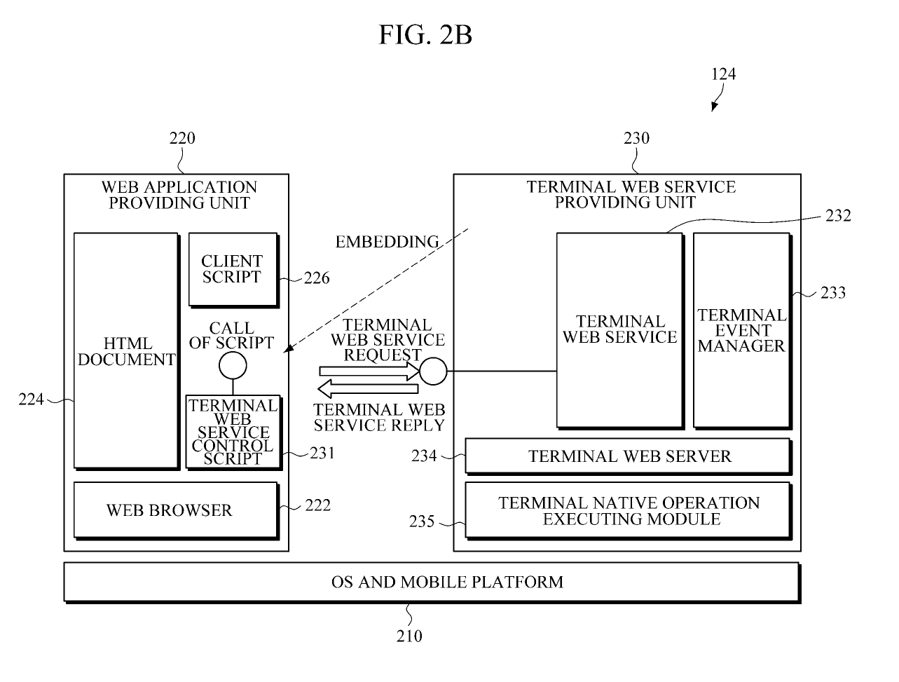

FIGS. 2A and 2B illustrate examples of a controller included in a terminal.

Referring to FIG. 2A, controller 124 includes an operating system (OS) and mobile platform 210, a web application providing unit 220, and a terminal web service providing unit 230. The OS and mobile platform 210 may represent a mobile platform and a mobile operating system, for example, WINDOWS MOBILE®, ANDROID®, LINUX® MOBILE, SYMBIAN®, and the like. The web application providing unit 220 and the terminal web service providing unit 230 may run on the OS and mobile platform 210.

The terminal apparatus 120 provides a terminal web service that may interact with local data and native operations of the terminal apparatus 120 by executing the web application 112 of the web server 110. For example, the web application providing unit 220 and the terminal web service providing unit 230 may communicate with each other according to a hypertext transport protocol (HTTP). For example, the web application providing unit 220 may send the terminal web service providing unit 230 a hypertext transport protocol (HTTP) request message that requests a reply by a terminal web service. In response, the terminal web service providing unit 230 may send the web application providing unit 220 an HTTP reply message for providing reply information made by the terminal web service.

The web application providing unit 220 may send the web server 110 information included in the HTTP reply message that is provided by the terminal web service providing unit 230. For example, the web application providing unit 220 may send information to the terminal web service providing unit 230 through the communicator 122. The web application 112 of the web server 110 may perform an operation based on the received information. For example, the web server 110 may send the terminal apparatus 120 a predetermined content and/or a java script written for a predetermined operation based on the information included in the HTTP reply message. Alternatively, the web server 100 may perform a predetermined operation such as storing the information included in the HTTP reply message in a predetermined storage area of the web server 110 and managing the information. In addition, the web application providing unit 220 may send the terminal web service providing unit 230 information that is received from the web server 110.

The web application providing unit 220 may include a web browser 222, an HTML document 224, and a client script 226. When the terminal apparatus 120 connects to the web server 110, data of a web page provided by the web application 112 may be downloaded from the web server 110. The HTML document 224 and the client script 226 represent data of the web application 112, running on the web server 110 shown in FIG. 1, and which may be downloaded to the terminal apparatus 120.

The web browser 222 executes the HTML document 224 and the client script 226. For example, the web browser 222 may be a mobile web browser running on a mobile terminal. The mobile web browser may support a full browsing such as does INTERNET EXPLORER®, OPERA®, CHROME LITE®, and the like support full browsing.

The HTML document 224 may be downloaded from the web server 110 to the terminal apparatus 120 and may be executed on the web browser 222. The downloaded client script 226 may be included in the HTML document 224 or downloaded along with the HTML document 224. For example, the client script 226 may be a java script.

The client script 226 may be associated with the terminal web service. Based on the execution of the client script 226, the web browser 222 may discover a terminal web service control script 231 that is provided by a terminal web server 234 included in the terminal web service providing unit 230. The client script 226 may enable the web service control script 231 to be embedded in the web application providing unit 220 such that the client script 226 is associated with a terminal web service.

The terminal web service providing unit 230 provides the web application providing unit 220 with data and native operations of the terminal. As an example, the data of the terminal may include various kinds of data stored in the terminal apparatus 120 for use, such as text messages, schedule information, location information, information about content playback history, photos, music files, moving pictures, and the like. The data of the terminal may be shared with other terminal apparatuses and/or may be stored in the terminal apparatus 120 in a predetermined standardized format. The native operations of the terminal may represent functions that are provided by executing various kinds of applications on the terminal apparatus 120, such as a photographing program, a music player, a call connection program, and the like.

The terminal web service providing unit 230 includes the terminal web service control script 231, a terminal web service 232, a terminal event manager 233, the terminal web server 234, and a terminal native operation executing module 235.

The terminal web service control script 231 is provided through the terminal web server 234. As shown in FIG. 2B, the terminal web service control script 231 may be embedded in the web application providing unit 220 by the downloaded client script 226 to provide a function for controlling association with respect to the data and native operations of the terminal.

The terminal web service 232 may be an HTTP based service that is provided through the terminal web server 234. The terminal web service 232 may be associated with data and/or native operations of the terminal apparatus 230 based on the execution of the client script 226 downloaded from the web server 110. In response to the HTTP request, the terminal web service 232 may provide a terminal web service reply, for example, through open standard protocols, such as JavaScript Object Notation (JSON), Simple Object Access Protocol (SOAP), XML, and the like.

The terminal event manager 233 receives various events occurring in the terminal apparatus 120 from the terminal native operation executing module 235, and stores and manages state information of the various events. An event occurring in the terminal apparatus 120 may include a hardware event occurring in hardware of the terminal apparatus 120 and a software event corresponding to a predetermined operation of an application that is executed in the terminal apparatus 120. For example, events may be registered in the terminal event manager 233 in advance, by execution of the client script 226. The terminal event manager 233 may provide the web application providing unit 220 with state information of the registered event from among the received events. The web application providing unit 220 may inquire into the state information of the registered events.

The terminal web server 234 may be a terminal-micro web server operating on the OS and mobile platform 210. For example, the terminal web server 234 may include basic functions of a general web server, such as APACHE®, and the like.

The terminal native operation executing module 235 runs programs included in the terminal, for example, a photographing program, a moving picture player, a music player, a phone call connection program, and the like. The terminal native operation executing module 235 executes and manages hardware/software functions of the terminal. For example, the terminal native operation executing module 235 may execute native operations of the terminal in response to a request transferred through a terminal web service. The terminal native operation executing module 235 may provide the terminal event manager 233 with various events occurring based on the execution of the native operations of the terminal.

If the client script 226 is downloaded to the terminal apparatus 120, the web application providing unit 220 may enable the web browser 222 to execute the client script 226 such that the web application providing unit 220 discovers the java script based terminal web service control script 231 retained in the terminal web service providing unit 230. The web application providing unit 220 may embed the terminal web service control script 231 in the web application providing unit 220, as shown in FIG. 2B. The web application providing unit 220 may inquire into the terminal web service 232, which is provided from the terminal web server 234, through the embedded terminal web service control script 231, and invoke a desired terminal web service.

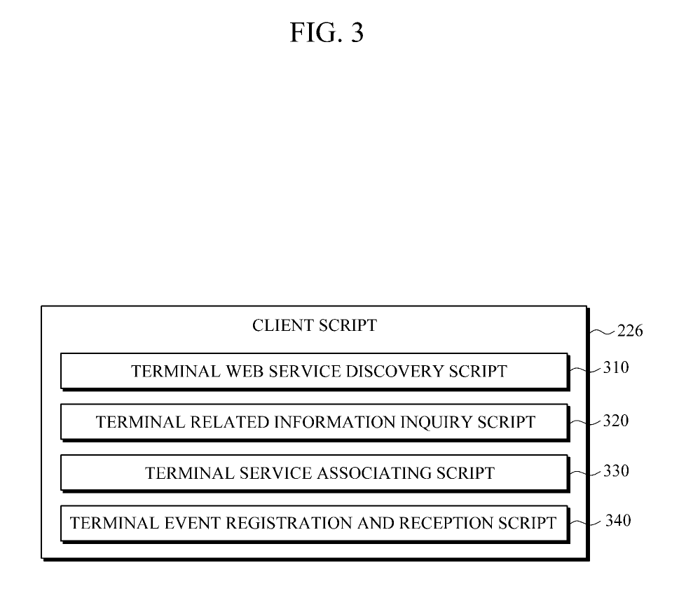

FIG. 3 illustrates an example of a client script included in a web application. For example, the web application may be downloaded to a terminal.

Referring to FIG. 3, the client script 226 may include a terminal web service discovery script 310, a terminal related information inquiry script 320, a terminal service associating script 330, and a terminal event registration and reception script 340. For example, the respective scripts 310, 320, 330, and 340 included in the client script 226 may be executed through the web browser 222 to perform respective operations.

Referring to FIGS. 2A-3, the terminal web service discovery script 310 may be used to discover the terminal web service control script 231 for providing a function with respect to the terminal web service 232. Accordingly, the terminal web service discovery script 310 is able to check if the terminal apparatus 120 serves to provide the terminal web service 232. Based on the execution of the terminal web service discovery script 310, the terminal web service control script 231 may be embedded in the web application providing unit 220 and may be executed. For example, the terminal web service control script 231 may be embedded by use of a script tag representing a predetermined file name of a predetermined port. The script tag may be configured to point to a uniform resource locator (URL) representing a storage address of the terminal web service control script 231. For example, the script tag may be <script src=http://localhost:1234/mobilewebservice.js/>.

The terminal related information inquiry script 320 may be used to inquire into information about a terminal that is provided from the terminal web service control script 231, after the terminal web service control script 231 is embedded through the terminal web service discovery script 310. The terminal related information inquiry script 320 may be written such that an inquiry into a terminal is performed by inquiring a Java Script Object Notation (JSON) file of a predetermined schema or through a Javascript Application Programming Interface (API) of a predetermined schema. The terminal related information to be inquired may selectively include various standard metadata about a terminal and service metadata provided by a terminal. For example, the terminal related information may be implemented using an XML standard, such as JSON, Resource Description Framework (RDF), Web Service Description Language (WSDL), and the like.

The terminal service associating script 330 is a script that is written to perform association with respect to a web service provided by a terminal. Based on the execution of the terminal service association script 330, a desired service of the web services provided by the terminal may be invoked. In addition, native data provided by the terminal apparatus 120 may be transferred to the web application providing unit 220, native operations of the terminal apparatus 120 may be invoked, and/or data downloaded from the web server 110 may be transferred to the terminal web server 234.

The terminal event registration and reception script 340 may include a terminal event registration script and a terminal event reception script. The terminal event registration script may be used to register an inquiry of a predetermined terminal event to inquire into a native event of a terminal. The terminal event reception script may be used to provide a handler based on the detection of a registered event. The terminal event reception script may include information that represents requirements of the registered event to operate the handler.

For example, the web application 112 of the web server 110 may provide a service in which, upon detection of a shake event of the terminal apparatus 120, a music currently being played is stopped and another music is played. In this example, the terminal event registration and reception script 340 may include a script for registering the shake event of the terminal apparatus 120 and for executing an operation of detecting whether the shake event is executed.

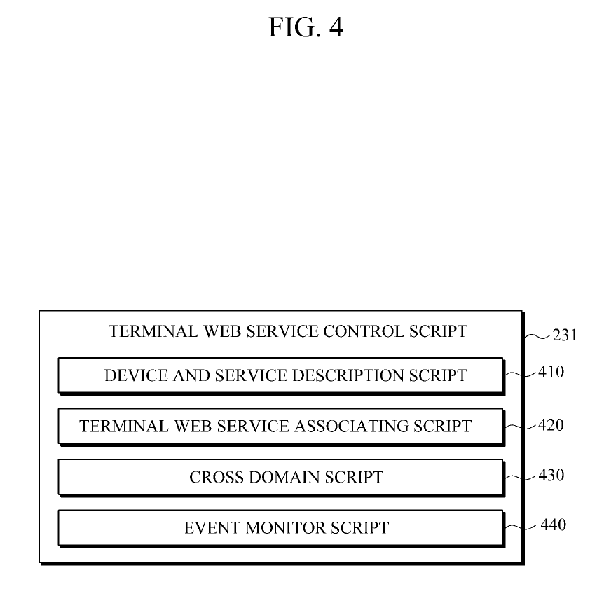

FIG. 4 illustrates an example of a terminal web service control script. For example, the terminal web service control script may be provided by a terminal.

Referring to FIGS. 2A-4, the terminal web service control script 231 includes a device and service description script 410, a terminal web service associating script 420, a cross domain script 430, and an event monitor script 440.

The device and service description script 410 includes a description about the terminal apparatus 120 and a description about a web service list provided by the terminal apparatus 120. Based on the execution of the terminal related information inquiry script 320, the device and service description script 410 is invoked. As described above, for example, the description information about the terminal apparatus 120 and the description about a web service list may be implemented in the form of an XML standard, such as JSON, RDF, WSDL, and the like.

The terminal web service associating script 420 may provide a list of java script functions for invoking a Representational State Transfer (REST) or a Simple Object Access Protocol (SOAP) based terminal web service for the terminal web service 232. It is not possible to attempt to invoke an Asynchronous JavaScript and XML (AJAX®) of another server from a script of a current page. Accordingly, to invoke a terminal web service provided by the terminal web server 234 regarded as another server from the embedded terminal web service associating script 420, a cross domain script 430 may be used.

The cross domain script 430 supports a cross domain enabling the association with respect to a web service, which is provided from another web server, through HTTP communication by use of a java script. For example, a representative cross domain scheme is a JavaScript Object Notation with Padding (JSONP).

The event monitor script 440 monitors an event corresponding to an event that is registered by the event registration and reception script 340. If the corresponding event is detected based on the execution of the event monitor script 440, the terminal event registration and reception script 340 may process information indicating the detection of the corresponding event by invoking a registered callback function.

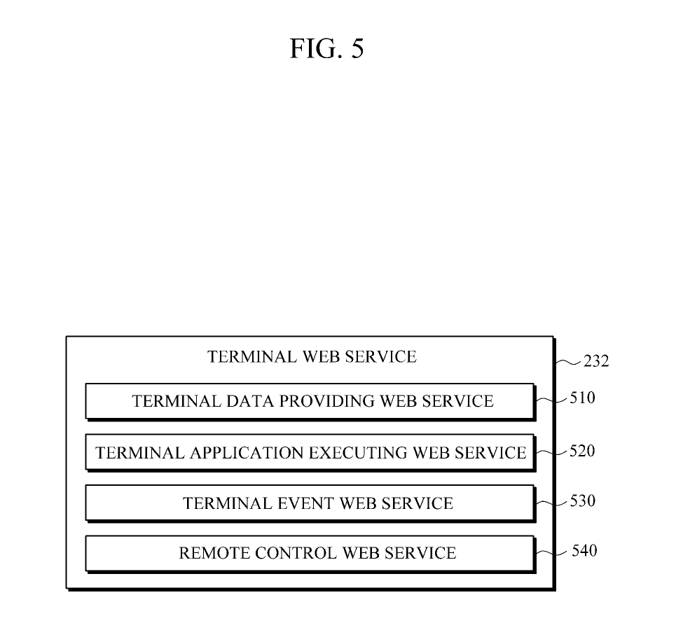

FIG. 5 illustrates an example of a web service provided by a terminal.

Referring to FIG. 2A-5, the terminal web service 232 may include a terminal data providing web service 510, a terminal application executing web service 520, a terminal event web service 530, and a remote control web service 540, but is not limited thereto.

The terminal data providing web service 510 may provide the web application providing unit 220 with various kinds of data of the terminal apparatus 120, for example, short message services (SMS), multimedia messaging services (MMS), schedule information, location information, playback history information, and the like. The terminal data providing web service 510 enables personal data stored in the terminal apparatus 120 to be selectively provided to the web application providing unit 220.

In addition, based on the execution of the terminal data providing web service 510, a predetermined data of the data included in the HTML document 224 may be delivered to the terminal web server 234 and stored in the storage 126 shown in FIG. 1. In this example, the selected data of the HTML document 224 may be stored in a data storage area for a predetermined application based on the data type.

For example, if the terminal apparatus 120 visits a blog which provides information about restaurants, a web page containing the information about restaurants may be stored to the HTML document 222 of the web application providing unit 220. In this example, phone numbers of the corresponding restaurants may be added to a list of phone numbers in the HTML document 222 which is managed by a phone number management application of the terminal apparatus 120.

The terminal application executing web service 520 enables programs, such as a photo viewer program and an mp3 player, installed in the terminal apparatus 120 to be invoked. The terminal application executing web service 520 enables native operations of the terminal apparatus 120, such as a calling function and a photographing function, to be executed.

The terminal event web service 530 enables an event occurring in the terminal apparatus 120 to be recorded and the recorded event to be externally inquired into. The terminal event web service 530 may include a terminal event registering web service and a terminal event inquiry web service.

The remote control web service 540 provides association with a remote control protocol if the terminal apparatus 120 has a remote control function for an external device such as a Universal Plug and Play (UPnP).

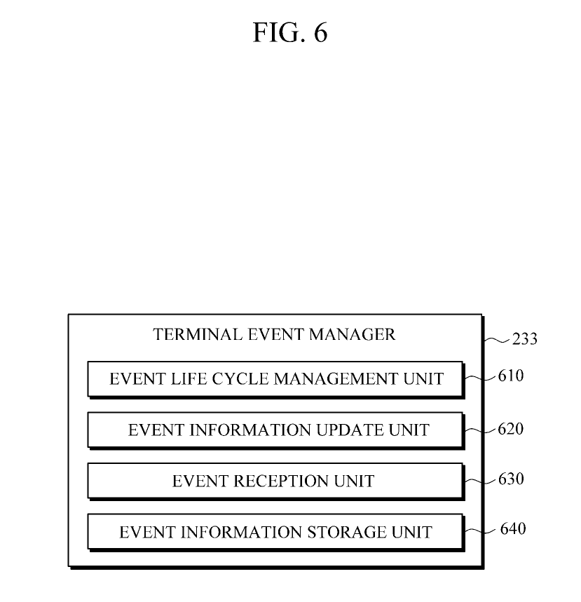

FIG. 6 illustrates an example of a terminal event manager. For example, the terminal event manager may be provided by a terminal.

Referring to FIGS. 2A-6, the terminal event manager 233 may include an event life cycle management unit 610, an event information update unit 620, an event reception unit 630, and an event information storage unit 640.

The event life cycle management unit 610 manages a life cycle of an event which is registered by the terminal event registration and reception script 340. For example, the event life cycle management unit 610 may remove information about the registered event if a web page that has requested an inquiry into the registered event is closed before the event is inquired into, or the event is not inquired into for a predetermined period of time.

The event information update unit 620 receives various events from the terminal native operation executing module 235, and if the received event is an event registered for inquiry, the event information update unit 620 updates state information about the corresponding event.

The event reception unit 630 receives events of the terminal apparatus 120 through the terminal native operation executing module 235 of the terminal web service providing unit 230.

The event information storage unit 640 stores state information about events, which are registered by the terminal event registration and reception script 340, from among the events received from the event reception unit 630. For example, if a registration of an event corresponding to a shake is achieved such that an event corresponding to a shake of the terminal apparatus 120 is inquired into, state information of the registered event stored in the event information storage unit 640 may be inquired into through the terminal event web service 530.

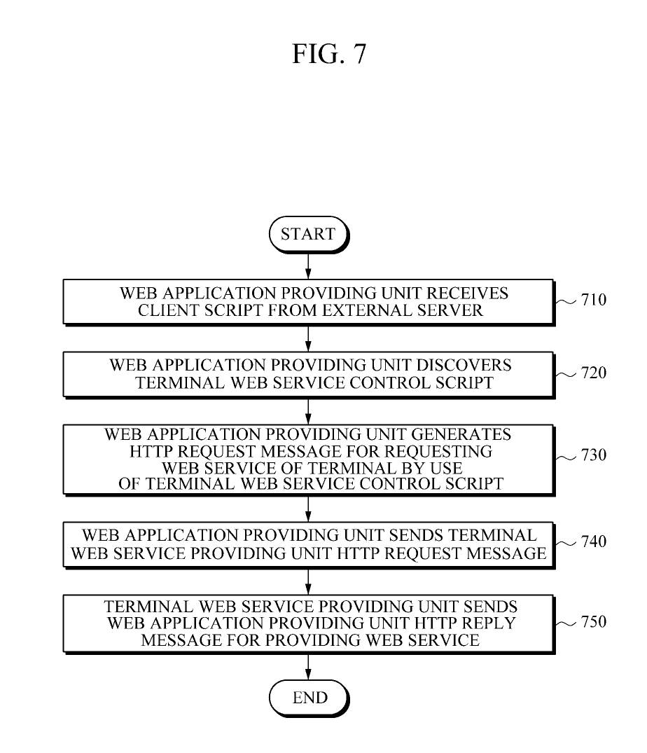

FIG. 7 illustrates an example of a method for providing a terminal web service.

Referring to FIG. 7, in 710 the web application providing unit receives the client script that is configured to be associated with the terminal web service, from the external web server. For example, the external server may be connected through a network.

In 720, the web application providing unit discovers the terminal web service control script, which controls association with respect to the terminal web service by use of the client script.

In 730, the web application providing unit generates an HTTP request message for requesting the terminal web service, by use of the terminal web service control script.

In 740, the web application providing unit sends the generated HTTP request message to the terminal web service providing unit.

In response to the reception of the HTTP request message, in 750 the terminal web service providing unit sends the web application providing unit an HTTP reply message for providing a web service related to at least one of data, application, and an event of the terminal. The web application providing unit may send the web server information included in the HTTP reply message, for example, data stored in the terminal apparatus, information indicating that execution of an application is completed, and information indicating that a predetermined event is detected.

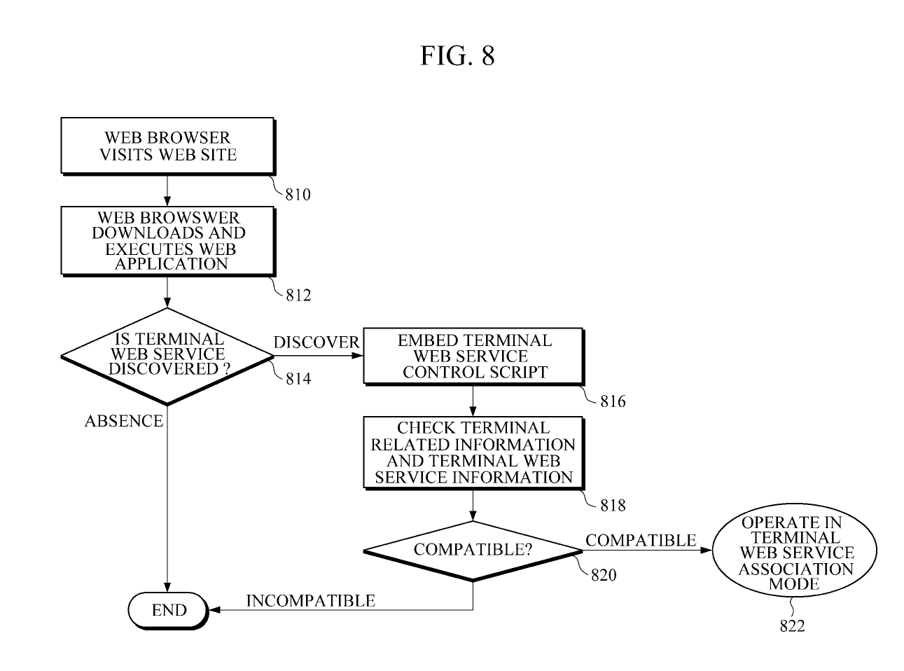

FIG. 8 illustrates an example of an initial process for a terminal web service association.

Referring to FIG. 8, the terminal apparatus accesses the web server through the web browser in 810. In 812, the web browser downloads and executes the HTML document of a web page and the client script that are provided by the web application of the web server.

As shown in FIG. 3, if the client script is configured to be associated with the terminal web service, in 814 the terminal web service discovery script 310 is executed and an operation of discovering the terminal web service of the terminal apparatus is performed.

If the terminal web service is discovered according to the execution of the terminal web service discovery script 310, in 816 the terminal web service control script is embedded in the web application providing unit.

The web browser executes the terminal related information inquiry script and as such the device and service description script of the terminal web service control script are inquired into, so that terminal related information and terminal web service information are checked, in 818.

Based on the information obtained through inquiry, the web browser checks the compatibility with respect to the terminal and the terminal web service, in 820. Available terminal related information and terminal web service information included in the terminal related information inquiry script may be compared with terminal related information and terminal web service information included in the device and service description script, thereby determining the compatibility. If the compatibility is assured, in 822 the terminal apparatus operates in a terminal web service association mode. If the terminal web service is not discovered in 814, or the compatibility is not assured in 820, the terminal apparatus stops the method.

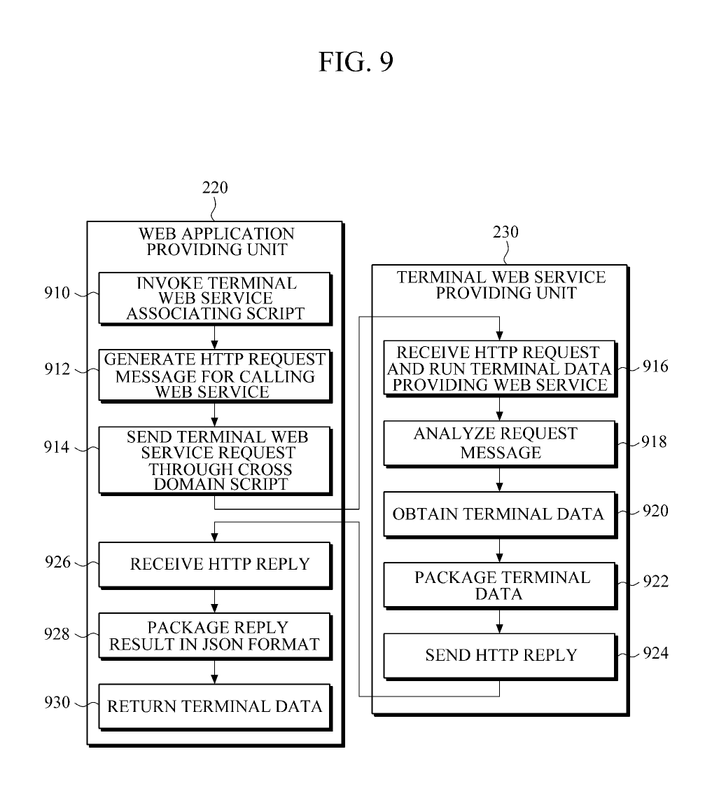

FIG. 9 illustrates an example of a method for providing a terminal data providing web service.

Referring to FIG. 9, if a terminal apparatus operates in a web service association mode, a terminal service associating script of a client script is executed, and in 910 the terminal web service associating script of a terminal web service control script embedded in the web application providing unit is invoked.

If a predetermined script of the terminal web service associating script, which is used to request the terminal data providing web service, is executed, in 912 an HTTP request message for invoking the terminal data providing web service of the terminal web service is generated.

Based on the execution of a cross domain script, in 914 the HTTP request message is delivered to the terminal web server.

In 916 the terminal web server receives the HTTP request message and executes the terminal data providing web service.

Based on the execution of the terminal data providing web service, the HTTP request message is analyzed in 918, and data requested by the HTTP request message is obtained from local data of the terminal apparatus in 920.

Based on execution of the terminal data providing web service, in 922 the terminal web server packages the obtained data into an open standardized format, such as SOAP, XML and JSON, and the like.

The terminal web server generates an HTTP reply message using the packaged data and sends the web application providing unit 220 the generated HTTP reply message in 924.

The web application providing unit receives the HTTP reply message in 926. According to the execution of the cross domain script, the HTTP reply message is processed by the terminal web service associating script.

For example, if a reply result according to the execution of the terminal web service associating script is not in a JSON format, the reply result is packaged in a JSON format such that the reply result is accessible on java scripts in 928.

Based on the execution of the terminal web service associating script in the web application providing unit, the packaged JSON data may return to the web application of the web server in 930. The web application may perform additional operations by use of the received data. For example, even if a user does not download and install uploading programs used to upload data to the web server, data such as photos and moving pictures, stored by the user may be uploaded to the web server through the web application.

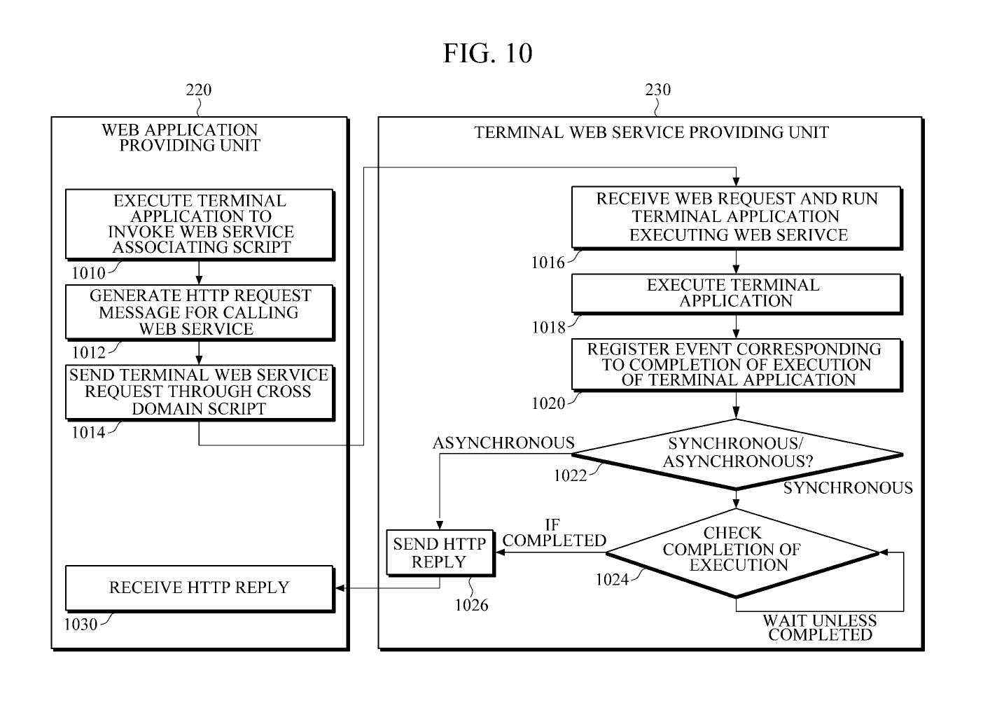

FIG. 10 illustrates an example of a method for providing a terminal application executing web service.

Referring to FIG. 10, based on the execution of the terminal service associating script of the client script in the web application providing unit, the terminal web service associating script of the embedded terminal web service control script is invoked in 1010.

If a predetermined script of the terminal service associating script for requesting the terminal application executing web service is executed, an HTTP request message for invoking the terminal application executing web service of the terminal web service is generated in 1012.

Based on the execution of the cross domain script, the HTTP request message is delivered to the terminal web server in 1014.

The terminal web server analyzes the HTTP request message and executes the terminal application executing web service in 1016. Based on the execution of the terminal application executing web service, a terminal application is executed through the terminal native operation executing module in 1018.

If the HTTP request message includes a terminal application and information about content that is to be executed on the corresponding terminal application, the corresponding content may be executed on the requested terminal application. For example, if the terminal apparatus visits a web page that provides music included in a music chart of the week, a music file provided by the corresponding web page may be downloaded to the terminal apparatus. In addition, the terminal service associating script may be downloaded to the terminal apparatus. The terminal service associating script may be written such that the preferred music is selected from music files and may be downloaded to the terminal apparatus, with reference to a previous playback list of the terminal apparatus. Based on the execution of the downloaded terminal service associating script, the terminal apparatus that displays a web page, executes a music player and plays a preferred music on the executed music program.

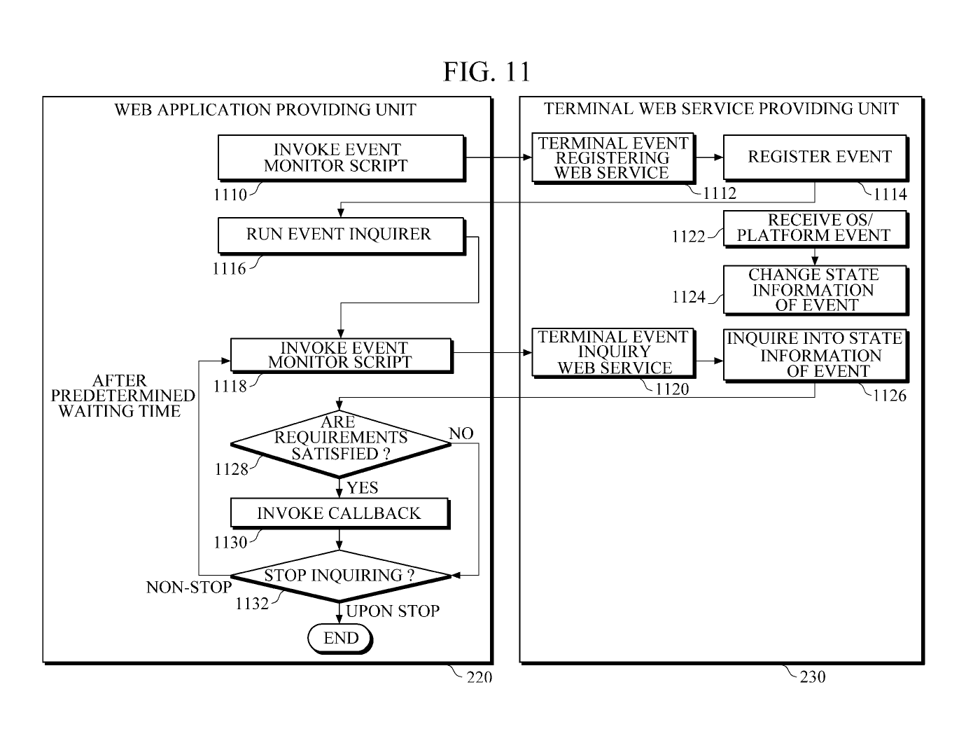

Upon performing 1018, an event corresponding to the running status of the terminal application may be registered through the terminal event manager in 1020. The event registration and inquiry is further described with reference to FIG. 11.

In 1022, whether an invocation of the terminal application executing web service requests the terminal application executing web service to operate in a synchronous mode or asynchronous mode is determined. If an invocation of the terminal application executing web service requests the terminal application executing web service to operate in a synchronous mode, the terminal web server checks whether the execution of the corresponding application is completed through the terminal event manager in 1024. If the execution is not completed, the terminal web server continues to check, waiting for the execution of the application to be completed in 1024.

If it is determined that the execution of the application is completed in 1024, the terminal web server sends the web application providing unit an HTTP reply message indicating that the execution of the application is completed in 1026.

If an invocation of the invocation of the terminal application executing web service requests the terminal application executing web service to operate in an asynchronous mode, the terminal web server may send the web application providing unit an HTTP reply message indicating that the application starts execution, even if the execution of the application is not completed. In this example, as the terminal event registration and reception script of the web application providing unit is executed, an event indicating whether the execution of the invoked application is completed is registered in the terminal event manager. In addition, in order to check whether the execution of the invoked application is completed, the event may be inquired into.

The HTTP reply message is delivered to the web application providing unit in 1030, and the HTTP reply message is processed by the terminal web service associating script based on the execution of the cross domain script. The web application 112 of the web server 110 may be notified of the completion of the execution of the terminal application.

FIG. 11 illustrates an example of a method for providing a terminal event web service.

Referring to FIG. 11, based on the execution of the terminal event registration and reception script of the client script, the event monitor script of the terminal web service control script is invoked in 1110. An HTTP request message of requesting a terminal event registering web service of the terminal event web service is generated. The terminal event registering web service makes a request for registering a terminal event that is to be inquired into. The generated HTTP request message is delivered to the terminal web server and the terminal event web service may be invoked in 1112.

The terminal web server executes the terminal event registering web service of the terminal event web service in 1114, thereby registering a predetermined event that may be inquired into in the event life cycle management unit of the terminal event manager.

If an event occurs in the terminal apparatus, the event reception unit of the terminal event manager receives the event in 1122. If the received event is a registered event, the event information update unit updates state information of the event and records the updated state information of the event in the event information storage unit in 1124.

After the registration for event inquiry is completed, based on the execution of the event registration and reception script of the client script, the event inquiry into the event is processed by running an event inquirer such as an additional process or thread in 1116. For example, an asynchronous inquiry may be performed through AJAX® which is a XmlHttpRequest.

Based on the execution of the event registration and reception script, the event monitor script is invoked. Based on the execution of the event monitor script, the terminal event inquiry web service of the terminal event web service is invoked in 1120.

The terminal web server inquires into state information of the event which is recorded in the event information storage unit of the event manager by running the terminal event web service, and sends the web application providing unit an HTTP reply message including the state information of the event in 1126.

Based on the execution of the event registration and reception script at the web application providing unit, the state information of the event is checked from the HTTP reply message, and it is checked whether changed state information satisfies the registered requirements of events in 1128. If the state information satisfies the registered requirements in 1128, a callback function is invoked according to the running of the event monitor script, the event registration and reception script is executed, and a handler which is set to operate when the registered requirement may be satisfied in 1130.

If a life cycle of the event is not ended, 1118 may be performed after a predetermined waiting time. If the state information of the event does not satisfy the registered requirements, 1118 is performed after a predetermined waiting time. If the inquiry operation stops in 1132, the event association ends.

The processes, functions, methods, and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A terminal apparatus comprising:
a web application providing unit configured to discover a terminal web service control script, which performs control to achieve association with respect to a terminal web service provided by the terminal apparatus, by executing the client script received from the external web server, and configured to generate a hypertext transport protocol (HTTP) request message for requesting the terminal web service by use of the terminal web service control script; and
a terminal web service providing unit configured to, upon reception of the HTTP request message, provide the terminal web service by sending the web application providing unit a HTTP reply message for providing reply information of the terminal web service.

2. The terminal apparatus of claim 1, wherein the client script is received in a rich internet application that runs based on a full browser.

3. The terminal apparatus of claim 1, wherein the web application providing unit embeds the terminal web service control script in the web application providing unit by use of the client script, and communicates with the terminal web service providing unit by use of the terminal web service control script.

4. The terminal apparatus of claim 1, wherein the web application providing unit sends information included in the HTTP reply message to the external web server and sends information received from the external web server to the terminal web service providing unit, by use of the client script.

5. The terminal apparatus of claim 4, wherein the terminal web service control script includes at least one of a device and service description script that indicates terminal related information and terminal web service information provided by the terminal apparatus, a terminal web service associating script written to call the terminal web service, a cross domain script that enables HTTP communication with the terminal web service through a java script, and an event monitor script that detects an event that occurs in the terminal web service providing unit.

6. The terminal apparatus of claim 1, wherein the terminal web service providing unit provides a terminal data providing web service that forms data stored in the terminal apparatus into the HTTP reply message and provides the HTTP reply message to the web application providing unit.

7. The terminal apparatus of claim 1, wherein the terminal web service providing unit provides a terminal application executing web service that executes an application executable in the terminal apparatus.

8. The terminal apparatus of claim 1, wherein, if the web application providing unit registers inquiry of at least one event occurring in the terminal apparatus by use of the client script, the terminal web service providing unit provides a terminal event web service that enables the web application providing unit to inquire into state information of the event.

9. The terminal of claim of 8, wherein the terminal web service providing unit further comprises a terminal event manager configured to manage an event occurring in the terminal apparatus and store state information of the event, and
the web application providing unit inquires into the stored state information of the event through the terminal event web service.

10. The terminal apparatus of claim 8, wherein the event includes a hardware event occurring in hardware of the terminal apparatus and a software event corresponding to a predetermined operation of an application executed in the terminal apparatus.

11. The terminal apparatus of claim 8, wherein the web application providing unit determines if obtained state information of an event satisfies a preset requirement by use of the client script, and if satisfied, runs a preset handler.

12. A method of providing a terminal web service of a terminal apparatus, the method comprising:
at a web application providing unit, receiving a client script, which is configured to be associated with a terminal web service provided by a terminal web server, from an external web server connected through a network;
at the web application providing unit, executing the client script received from the external web server to discover a terminal web service control script, which performs control to achieve association with respect to the terminal web service, by use of the client script;
at the web application providing unit, generating an HTTP request message for requesting the terminal web service by use of the terminal web service control script;
at the web application providing unit, sending the generated HTTP request message to a terminal web service providing unit; and
at the terminal web service providing unit, sending the web application providing unit a HTTP reply message for providing the terminal web service, upon reception of the HTTP request message.

13. The method of claim 12, further comprising, at the web application providing unit, embedding the terminal web service control script into the web application providing unit by use of the client script.

14. The method of claim 12, wherein the sending of the HTTP reply message for providing the web service to the web application providing unit comprises providing a terminal data providing web service that generates data stored in the terminal apparatus into the HTTP reply message and provides the HTTP reply message to the web application providing unit.

15. The method of claim 12, wherein the sending of the HTTP reply message for providing the web service to the web application providing unit comprises providing an execution result of a terminal application executing web service that executes an application executable in the terminal apparatus.

16. The method of claim 12, wherein the sending of the HTTP reply message for providing the web service to the web application providing unit comprises providing a terminal event web service that allows the web application providing unit to inquire into state information of an event.

17. The method of claim 12, further comprising, at the terminal web service providing unit, managing an event occurring in the terminal apparatus and storing state information of the event,
wherein the sending of the HTTP reply message for providing the web service to the web application providing unit comprises inquiring into the stored state information of the event according to the execution of the terminal event web service and sending the web application providing unit obtained state information.

18. A terminal comprising:
a web application providing unit configured to receive data including a client script of a web application running on an external web server, from the external web server, configured to execute the client script to discover a terminal web service control script that corresponds to a terminal web service that enables a browsing service to be used with data and native operations of the terminal, and configured to transmit a request for the terminal web service; and
a terminal web service providing unit configured to receive the terminal web service request and configured to provide the terminal web service and the data and native operations of the terminal based on the terminal web service control script.

19. The terminal of claim 18, wherein the data and the native operations of the terminal provided to the web application providing unit include at least one of short message services (SMS), multimedia messaging services (MMS), schedule information, location information, and playback history information.

20. The terminal of claim 18, wherein the terminal web service enables native programs of the terminal to be invoked by the web application running on the external web server, and the programs include at least one of a photo viewer program and an mp3 player installed in the terminal.
